(19) United States
(12) Patent Application Publication
(10) Pub. No.: US 2015/0337100 A1
(43) Pub. Date: Nov. 26, 2015

(54) TRANSPARENT POLYIMIDE SUBSTRATE AND METHOD OF MANUFACTURING THE SAME

(71) Applicants: Hak Yong WOO, Seoul (KR); Hak Gee JUNG, Yongin-si, Gyeonggi-do (KR); Sang Yoon PARK, Yongin-si, Gyeonggi-do (KR)

(72) Inventors: Hak Yong WOO, Seoul (KR); Hak Gee JUNG, Yongin-si, Gyeonggi-do (KR); Sang Yoon PARK, Yongin-si, Gyeonggi-do (KR)

(73) Assignee: KOLON INDUSTRIES, INC, Gwacheon-si, Gyeonggi-do (KR)

(21) Appl. No.: 14/410,839

(22) PCT Filed: Jun. 25, 2012
(86) PCT No.: PCT/KR2012/005003

§ 371 Date: Jun. 23, 2015

(51) Int. Cl. C08J 7/06; C09D 1/00; B29C 71/02

(52) U.S. Cl. CPC C08J 7/06; C08J 7/08; C09D 1/00; C08J 2379/08

(57) ABSTRACT

Disclosed herein is a transparent polyimide substrate, including: a transparent polyimide film; and a silicon oxide layer which is formed on one side or both sides of the transparent polyimide film and which includes a silicon oxide.

### TECHNICAL FIELD

The present invention relates to a transparent polyimide substrate which can be used as a flexible display substrate, and a method of manufacturing the same.

### BACKGROUND ART

Recently, electronic appliances, such as flexible OLEDs, color EPDs, plastic LCDs, TSPs, OPVs and the like, have attracted considerable attention as next-generation displays that can be easily warped and bent. In order to manufacture such flexible displays that can be easily warped and bent, a new type of substrate is needed to replace conventional glass substrates. Such a new type of substrate must have enough chemical resistance, heat resistance and optical transmittance to protect the parts of the display. Further, such a new type of substrate must be resistant to solvents used in cleaning, peeling, etching and the like performed in the process of manufacturing a display, and needs to be resistant to high temperature.

Various plastic substrates are being considered as candidates of flexible display substrates. Among these plastic substrates, a transparent polyimide film is considered as a major candidate.

In order to improve the solvent resistance of a transparent polyimide film considered as a flexible display substrate, conventionally, methods of forming an acrylic-based or epoxy-based organic curing film on a transparent polyimide film have been used. However, such an organic curing film is problematic because its heat resistance deteriorates at a high temperature of above 200° C. or at a high temperature of 300° C. or more.

### DISCLOSURE OF INVENTION

### Technical Problem

Accordingly, the present invention has been made to solve the above-mentioned problems, and an object of the present invention is to provide a transparent polyimide substrate having excellent solvent resistance and high heat resistance.

Another object of the present invention is to provide a method of manufacturing a transparent polyimide substrate having excellent solvent resistance and high heat resistance.

### Solution to Problem

In order to accomplish the above objects, an aspect of the present invention provides a transparent polyimide substrate, including: a transparent polyimide film; and a silicon oxide layer which is formed on one side or both sides of the transparent polyimide film and which includes a silicon oxide having a unit structure represented by Formula 1 below:

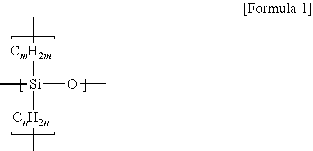

wherein m and n are each independently an integer of 0 to 10.

Another aspect of the present invention provides a method of manufacturing a transparent polyimide substrate, including the steps of: applying a polysilazane-containing solution onto one side or both sides of a transparent polyimide film and then drying the solution to form a polysilazane layer; and curing the polysilazane layer.

### Advantageous Effects of Invention

There is provided a transparent polyimide substrate having excellent solvent resistance and high heat resistance.

Further, there is provided a method of manufacturing a transparent polyimide substrate having excellent solvent resistance and high heat resistance.

### BEST MODE FOR CARRYING OUT THE INVENTION

The present invention provides a transparent polyimide substrate, including: a transparent polyimide film; and a silicon oxide layer which is formed on one side or both sides of the transparent polyimide film and which includes a silicon oxide having a unit structure represented by Formula 1 below:

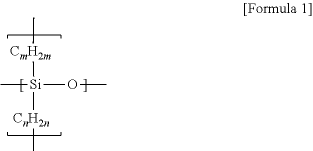

wherein m and n are each independently an integer of 0 to 10.

That is, a silicon oxide layer is formed on one side or both sides of a transparent polyimide film, thus improving the solvent resistance and heat resistance of the transparent polyimide film. In Formula 1, when n or m is 0, the silicon oxide layer is a pure inorganic material, thus maximizing the solvent resistance and heat resistance of the transparent polyimide film. If necessary, in order to improve the flexibility of the transparent polyimide substrate, it is preferable that, in Formula 1, n or m be a natural number of 1 or more, so that the silicon oxide has the proper alkyl chain length. However, when n or m is 10 or more, the silicon oxide has hydrophobicity, thus causing the agglomeration of a coating solution.

Here, the thickness of the silicon oxide layer may be 0.3˜2.0 μm. It is preferred that the thickness of the silicon oxide layer be 0.3 μm or more in order to impart the transparent polyimide film with proper solvent resistance, and it is preferred that the thickness thereof be 2.0 μm or less in order to prevent the flexibility of the transparent substrate from being deteriorated.

As such, the transparent polyimide substrate provided with the silicon oxide layer according to the present invention has excellent solvent resistance to such an extent that a change in its appearance is not observed by the naked eye even when it is dipped in an organic solvent, such as TMAH (tetramethylammonium hydroxide), KOH (potassium hydroxide), NMP (N-methylpyrrolidone), MEK (methyl ethyl ketone), MASO₂ (a solvent containing 16.9˜20.3% of HCL, manufactured by Dongwoo Finechem Co., Ltd.) or the like used in an etching process or the like in the manufacture of displays at room temperature for about 30 minutes.

Further, the transparent polyimide substrate of the present invention is provided on the surface thereof with the silicon oxide layer, so that its surface roughness (RMS) may be reduced to 5 nm or less, thereby bringing about the advantage of flattening the transparent polyimide substrate. Because of this advantage, carriers can easily move during a process of forming electrodes or TFT.

Further, the present invention provides a method of manufacturing a transparent polyimide substrate, including the steps of: applying a polysilazane-containing solution onto one side or both sides of a transparent polyimide film and then drying the solution to form a polysilazane layer; and curing the polysilazane layer.

That is, the method of manufacturing a transparent polyimide substrate according to the present invention is characterized in that the transparent polyimide film is coated with polysilazane and then cured, so that a —NH— group existing in the unit structure of Formula 2 is converted into an —O— group existing in the unit structure of Formula 1, thereby forming the silicon oxide layer.

As a conventional deposition method of forming an inorganic layer on a film, PECVD or sputtering is disadvantageous in that the deposition area is restricted due to the limitations of the vacuum equipment. However, the method of forming an inorganic layer by coating a film with a solution and then curing the solution according to the present invention is advantageous in that it can be conducted using a simple casting process, and thus it is very effective in large-area and continuous processes.

Here, the polysilazane may include a unit structure represented by Formula 2 below:

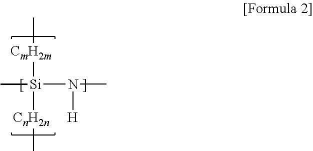

wherein m and n are each independently an integer of 0 to 10.

Further, the polysilazane may have a weight average molecular weight of 1,000˜5,000.

In Formula 1, m and n may be suitably selected depending on the characteristics of the finally-formed silicon oxide layer. Further, when the weight average molecular weight of polysilazane is 1,000 or more, higher solvent resistance and heat resistance can be ensured, and, when the weight average molecular weight thereof is 5,000 or less, uniform coatability can be ensured.

The process of applying the polysilazane-containing solution onto one side or both sides of the transparent polyimide film may be carried out using any one selected from among spray coating, bar coating, spin coating, dip coating, and the like.

Here, the process of forming the silicon oxide layer by converting the —NH— group existing in the unit structure of Formula 2 into the —O— group existing in the unit structure of Formula 1 may be carried out using thermal curing or UV curing.

Here, thermal curing is advantageous in that a network structure necessary to easily convert polysilazane into a silicon oxide film can be easily formed, so that the film characteristics of the silicon oxide film can be enhanced, thereby greatly improving the chemical resistance and heat resistance of the transparent polyimide substrate, but is disadvantageous in that process temperature must be increased to 200˜300° C. Meanwhile, UV curing is advantageous in that polysilazane can be converted into a silicon oxide film in a short period of time by irradiating the polysilazane with UV, but is disadvantageous in that the film characteristics of the silicon oxide film cannot be enhanced because the network structure is partially formed compared to thermal curing. Therefore, thermal curing and UV curing can be selectively used depending on the physical properties of the final product or the advantages and disadvantages of processes.

When thermal curing is selected, polysilazane can be heat-treated at a temperature of 200˜300° C. In this case, when the heat treatment temperature is 200° C. or above, the curing time that it takes to form polysilazane into a silicon oxide layer can be reduced, and when the heat treatment temperature is 300° C. or lower, it is possible to prevent the warpage caused by the difference in thermal expansion coefficient between the transparent polyimide film and the silicon oxide layer.

When UV curing is selected, in the step of applying the polysilazane-containing solution, the polysilazane-containing solution may further include a UV curing agent, and, in the step of curing the polysilazane layer, the polysilazane layer may be cured by irradiating it with UV having a short wavelength of 312 nm or 365 nm at a radiation intensity of 1500˜4000 J/m².

Here, the UV curing agent may include any one selected from a benzoin ether photoinitiator, a benzophenone photoinitiator and a mixture thereof.

### Mode for the Invention

Hereinafter, the present invention will be described in detail with reference to the following Examples.

### Comparative Example 1

A transparent polyimide film, the surface of which was not processed at all, is provided as Comparative Example 1.

### Example 1

Polysilazane represented by Formula 2 wherein m and n are 0 and having a molecular weight of about 2,000 was dissolved in DBE (dibutyl ether) in a concentration of 2 wt % to obtain a polysilazane-containing solution. Subsequently, the polysilazane-containing solution was applied onto one side of the transparent polyimide film of Comparative Example 1 by a wire, and then dried at a temperature of about 80° C. to form a polysilazane film having a thickness of 1 μm.

Thereafter, the polysilazane film was left at room temperature for about 5 minutes, and was then thermally cured at a temperature of about 250° C. to form a silicon oxide layer.

### Example 2

A silicon oxide layer was formed in the same manner as in Example 1, except that polysilazane represented by Formula 2 wherein m is 0 and n is 1 or m and n are 1 and having a molecular weight of about 3,000 was used.

### Example 3

A silicon oxide layer was formed in the same manner as in Example 1, except that polysilazane-containing solution was applied onto both sides of the transparent polyimide film.

### Example 4

A silicon oxide layer was formed in the same manner as in Example 2, except that polysilazane-containing solution was applied onto both sides of the transparent polyimide film.

### Example 5

Polysilazane represented by Formula 2 wherein m and n are 0 and having a molecular weight of about 2,000 was dissolved in DBE (dibutyl ether) in a concentration of 2 wt % to obtain a first solution. Subsequently, a UV curing agent was added to and then dissolved in the first solution to obtain a second solution. Then, the second solution was applied onto one side of the transparent polyimide film of Comparative Example 1 by a wire, and then dried at a temperature of about 80° C. to form a polysilazane film having a thickness of 1 μm.

Thereafter, the polysilazane film was irradiated with UV having a short wavelength of 312 nm or 365 nm at a radiation intensity of 27 W/m² for 60 seconds using a UV curing unit to obtain a colorless transparent polyimide film provided with a silicon oxide layer.

Measurements of the solvent resistance and other physical properties of the colorless transparent polyimide films manufactured in Examples 1 to 4 and Comparative Example 1 were conducted as follows.

[Measurement of Physical Properties]

The physical properties thereof were measured using the following method, and the results thereof are given in Table 1 below.

Solvent Resistance

The solvent resistance of each of the transparent polyimide films was evaluated after they had been dipped in the organic solvents given in Table 1 at room temperature for 30 minutes, respectively. In the case where each of the transparent polyimide films was observed with the naked eye, when its appearance did not change, and the difference in RMS between before the dipping test and after the dipping test was less than 1 nm, the solvent resistance thereof was represented by ⊚. Further, in the case where each of the transparent polyimide films was observed with the naked eye, when its appearance did not change, and the difference in RMS between before the dipping test and after the dipping test was 1 nm or more, the solvent resistance thereof was represented by ◯. Furthermore, in the case where each of the transparent polyimide films was observed with the naked eye, when each of the transparent polyimide films became white and turbid or was spotted, the solvent resistance thereof was represented by X. The results thereof are given Table 1 below.

Average Optical Transmittance (%)

The average optical transmittance of each of the transparent polyimide films at a wavelength of 350˜700 nm was measured using a spectrometer (CU-3700D, manufactured by Konica Minolta Corp.).

Yellow Index

The yellow index of each of the transparent polyimide films was measured using a spectrometer (CU-3700D, manufactured by Konica Minolta Corp.).

Thermal Expansion Coefficient (CTE) (ppm/° C.)

The thermal expansion coefficient (CTE) (ppm/° C.) of each of the transparent polyimide films at 50˜250° C. was measured using a thermal analysis instrument (TA Instrument Q-400).

Oxygen Permeability (cc/cmz*day)

The oxygen permeability of each of the transparent polyimide films was measured using an oxygen permeation meter (MOCON/US/Ox-Tran 2-61).

Surface Roughness (RMS) (nm)

The surface roughness of each of the transparent polyimide films was measured in 20*20 μm using XE100 AFM.

Adhesivity

The adhesivity of each of the transparent polyimide films was measured by taping the film 100 times according to ASTM D3359.

Heat Resistance

Each of the transparent polyimide films was sufficiently dried to remove moisture therefrom, was left in a hot air oven for 24 hours under a nitrogen atmosphere of 300° C., and then the rate of change in the weight thereof was measured. In this case, when the rate of change in the weight thereof was less than 1%, the heat resistance thereof is represented as excellent. Further, when the rate of change in the weight thereof was 1% or more, the heat resistance thereof is represented as poor.

TABLE 1

| Class. | IPA | TMAH | KOH | NMP | MEK | MASO₂ |
|---|---|---|---|---|---|---|
| Exp. 1 | ⊚ | ⊚ | ⊚ | ⊚ | ⊚ | ⊚ |
| Exp. 2 | ⊚ | ⊚ | ⊚ | ⊚ | ⊚ | ⊚ |
| Exp. 3 | ⊚ | ⊚ | ⊚ | ⊚ | ⊚ | ⊚ |
| Exp. 4 | ⊚ | ⊚ | ⊚ | ⊚ | ⊚ | ⊚ |
| Comp. | ⊚ | ◯ | X | X | X | ◯ |
| Exp. 1 | | | | | | |

TABLE 2

| | Average optical | | | Oxygen | | | Heat |
|---|---|---|---|---|---|---|---|
| | transmittance | Yellow | CTE | permeability | RMS | | resistance |
| Class. | (%) | index | (ppm/° C.) | (cc/cm²*day) | (nm) | Adhesivity | (300° C./30 min) |
| Exp. 1 | 92 | 2.29 | 26.95 | 1.90 | 0.582 | 5B | excellent |
| Exp. 2 | 91 | 2.01 | 26.98 | 1.87 | 0.581 | 5B | excellent |
| Exp. 3 | 90 | 1.95 | 26.55 | 1.14 | 0.583 | 5B | excellent |
| Exp. 4 | 90 | 2.86 | 26.71 | 1.28 | 0.553 | 5B | excellent |
| Comp. | 89 | 3.06 | 28.78 | 6.48 | 3.798 | — | excellent |
| Exp. 1 | | | | | | | |

Testing the solvent resistance of the transparent polyimide films of Examples 1 to 4 and Comparative Example 1, as given in Table 1 above, showed that the solvent resistance of the transparent polyimide films of Examples 1 to 4 against all of the solvents was represented by 0, that is, the evaluation showed that, when each of the transparent polyimide films was observed with the naked eye, its appearance did not change, and the difference in RMS between before and after the dipping test was less than 1 nm. However, the solvent resistance of the transparent polyimide film of Comparative Example 1 to all of the solvents was evaluated as poor, except for some solvents.

Further, since each of the transparent polyimide films of Examples 1 to 4 was provided on the surface thereof with a silicon oxide layer, the average optical transmittance, yellow index, CTE, oxygen permeability, surface roughness (RMS) and adhesivity thereof were improved compared to those of the transparent polyimide film of Comparative Example 1, the surface of which had not been processed at all.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A transparent polyimide substrate, comprising:
a transparent polyimide film; and
a silicon oxide layer which is formed on one side or both sides of the transparent polyimide film and which includes a silicon oxide having a unit structure represented by Formula 1 below: 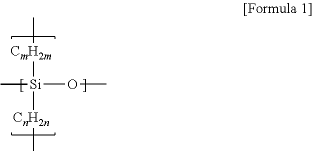
wherein m and n are each independently an integer of 0 to 10.

2. The transparent polyimide substrate of claim 1, wherein the silicon oxide layer has a thickness of 0.3˜2.0 μm.

3. The transparent polyimide substrate of claim 1, wherein the silicon oxide layer has a surface roughness (RMS) of 5 nm or less.

4. A method of manufacturing a transparent polyimide substrate, comprising the steps of:
applying a polysilazane-containing solution onto one side or both sides of a transparent polyimide film and then drying the solution to form a polysilazane layer; and
curing the polysilazane layer.

5. The method of claim 4, wherein the polysilazane includes a unit structure represented by Formula 2 below: 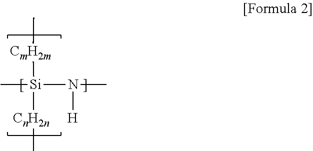
wherein m and n are each independently an integer of 0 to 10.

6. The method of claim 5, wherein the polysilazane has a weight average molecular weight of 1,000˜5,000.

7. The method of claim 4, wherein the polysilazane layer has a thickness of 0.3˜2.0 μm.

8. The method of claim 4, wherein, in the step of curing the polysilazane layer, the polysilazane layer is thermally cured by performing heat treatment at a temperature of 200˜300° C.

9. The method of claim 4, wherein, in the step of applying the polysilazane-containing solution, the polysilazane-containing solution further includes a UV curing agent,
and, in the step of curing the polysilazane layer, the polysilazane layer is cured by irradiating it with UV having a short wavelength of 312 nm or 365 nm at a radiation intensity of 1500˜4000 J/m².

10. The method of claim 9, wherein the UV curing agent includes any one selected from a benzoin ether photoinitiator, a benzophenone photoinitiator and a mixture thereof.
